(19) United States
(12) Patent Application Publication
(10) Pub. No.: US 2004/0151185 A1
(43) Pub. Date: Aug. 5, 2004

(54) Method and device for processing multiplexed flow data

(76) Inventors: Arnaud Boursier, Nans les pins (FR); Gilles Gautier, Eygalieres (FR)

Correspondence Address: Finnegan Henderson Farabow Garrett & Dunner, 1300 I Street N W, Washington, DC, 20005-3315, US

(21) Appl. No.: 10/475,123

(22) PCT Filed: Apr. 18, 2002
(86) PCT No.: PCT/FR02/01332

(30) Foreign Application Priority Data
Apr. 19, 2001 (FR) 01/05280

(51) Int. Cl. H04L 12/56

(52) U.S. Cl. 370/395.3; 370/428

(57) ABSTRACT

The invention relates to a method and device for processing multiplexed flow data wherein data is organized in the form of packets provided with an identifier enabling description of the source to which said data contained therein belongs. The inventive method comprises a data filtering step. According to the invention a) a table of correspondence is established, associating each identifier with a processing context, b) the identifier for each incoming packet is recognized, the data thereof is filtered using the filtering parameters of the processing context thereof, the filtered data is stored when a new incoming packet is detected. The invention can be used for digital broadcasting such as digital television, digital radio or to broadcast computer data.

### TECHNICAL FIELD

The present invention relates to a method and a device for processing data of a multiplexed flow.

### BACKGROUND

In this domain the flow, which is received by a distant receiver, is multiplexed, that is the data is organized in packets comprising each an identifier that allows recognition of the data type contained and specially the channel represented by the packets.

For each channel there are different data layers present in the packet.

On reception of such multiplexed flow, a processing step is necessary to restore different data flows according to the data channels (e.g. audio, video, data).

In this domain a demultiplexer device is known by the document FR-A-2.743.245 which comprises means for storing data of a multiplexed flow, programmable means for storing data filters, means for comparing the data of the multiplexed flow with the data filters and means for transferring the data of the multiplexed flow to storage means as a function of the realized comparison.

This demultiplexer device is complex and comprises a plurality of filtering processors.

It is essentially directed to filtering processes relative to each transport layer of each data packet.

### SUMMARY OF THE INVENTION

The present invention relates to a method and a device for processing the data of a multiplexed flow advantageously.

Within this scope a single filtering processor is used for all filtering steps that are to be executed on the different packet types comprised in the flow, according to their identifier commonly named Channel identifier, Channel in the sense data flow and not in the sense television channel. The identifier is a number that describes to which source the packet data belong; in the case of digital television the source could be e.g. audio, video or information data. Consequently, the invention reduces considerably the structural massiveness of the filter circuit, which contained up to now as many filters as packet types.

The present invention relates to a method for processing data of a multiplexed flow in which the data are organized in packets comprising an identifier that allows to describe to which source the data contained in the packet belong, the method comprising a data filtering step, characterized by the fact that

a) a cross-reference table is established in which each identifier is associated with a processing context,

b) for each entering packet:

its identifier is recognized

its data are filtered using the filtering parameters of its processing context

the filtered data are stored when the arrival of a new packet is detected.

### BRIEF DESCRIPTION OF THE DRAWINGS

The accompanying drawings are given as illustrative and not limiting examples. They represent a preferred embodiment according to the invention. They will help to understand easily the invention.

FIG. 1 is a bloc diagram representing the elements of the present invention.

FIG. 2 is an example of the arborescent structure of the filters of one context.

### DETAILED DESCRIPTION

The invention applies especially to filtering data received within the scope of digital diffusion for example digital television transmission, in particular by satellite.

Above all, the invention allows filtering data that is received in a multiplexed manner, e.g. in the standardized MPEG format.

An advantage of the invention lies in the continuous processing of the multiplexed signal with a temporary storage and the possibility to mark the filtered data allowing their identification for a later utilization.

It is another objective of the invention to combine advantageously a hardware with a software structure.

On the hardware level, the processor executes several programs simultaneously; the identifier of each packet to which the entering data is associated automatically determines when to pass from one program to another.

Therefore a multitasking processor hardware is used.

On the software level, the filters are not any longer processed separately but advantageously all the filters, which are related to one packet identifier, are compiled in an arborescent manner thus allowing to deduce a filtering program that is executed in an optimized manner by the multitasking processor.

Other objectives and advantages will appear in the following not limiting description, which shows a particular embodiment of the invention in detail.

A method for processing data of a multiplexed flow may comprise the following steps:

at each change of the processing context to be used the filtered data are stored with the foregoing context in a FIFO register of the first-in first-out type and a FIFO register pointer is associated to them;

to the data filtered with a particular context marking data are added for marking with the identifier of the packet to which they belong and marking with the filter that was used for their filtering;

the filtering parameters of each processing context comprise one or a plurality of filters each being provided with characteristics of data filtering, of mask and of length;

the filtering is executed by organizing the filters arborescently, where the common elements are grouped together on a same branch.

The invention also relates to a device for processing data of a multiplexed flow in which the data are organized in packets comprising an identifier corresponding to the type of data it contains, the device comprising means for data filtering, which can be used by the method, characterized by that it comprises:

means for storing a cross-reference table that associates each identifier with a processing context,

means for detecting the identifier of a packet entering the device

a filtering processor that is associated with a memory which contains the filtering parameters included in each processing context

means for storing the filtered data

for filtering the data of a packet according to filtering parameters which are applied to the filtering processor after recognition of the packet identifier and association of the processing context which contains these filtering parameters to this identifier.

In particular, according to preferred embodiments:

the means for storing the filtered data consist of a FIFO register of the first-in first-out type, whose pointers are associated with the filtered data according to their context;

it contains a marker to add marking data to the filtered data for marking with the identifier of the packet to which they belong and with the filter that was used for their filtering;

the multiplexed flow is a flow of digital broadcasting;

the multiplexed flow is a digital television flow.

Usually, a multiplexed flow is composed of data packets, each containing an identifier, generally named Channel ID allowing to know the source of the data contained in the packet.

In the scope of a preferred application in the digital television, each packet corresponds to a television channel.

On reception, especially by an end user, it is necessary to demultiplex the flow for its utilization.

This includes a filtering of the packets contained in the multiplexed flow.

The device according to the invention allows the processing and specially the necessary filtering.

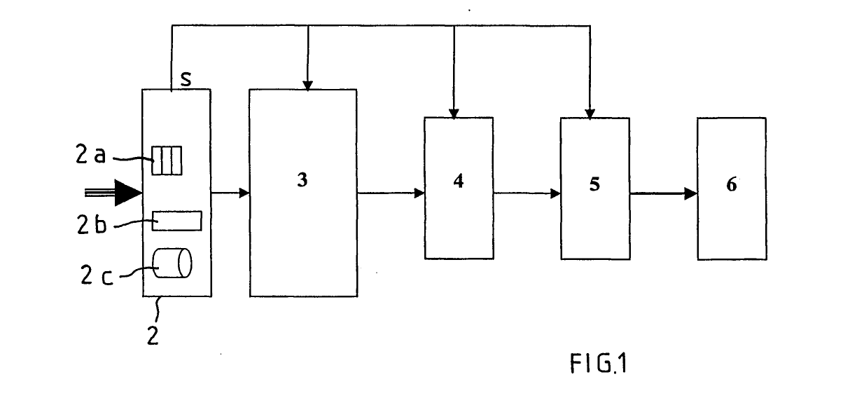

With reference to FIG. 1, arrow 1 indicates the entering multiplexed flow.

This flow is received by a controller 2, which performs a step of recognition of the entering packet identifier. The controller 2 may be for example a component like an ASIC or a FPGA.

Advantageously, the controller 2 comprises a stack 2a of the type first in first out for regulating the entering data stream according to the processing time needed in the following constituent bloc of the present invention.

2b in FIG. 1 represents the means of detection, which are in the controller 2 and allow identifying the entering packet identifier.

All current means of recognition of the Channel ID may be used here.

Further on in the description the identifier of a packet will be designated as Channel ID, and context will be used for the whole parameters for the processing to be done comprising the necessary filtering parameters relative to a special Channel ID (that is for the type of packet).

Each Channel ID, i.e. each packet type corresponds to a TV program channel for a digital television application.

As schematically shown in FIG. 1, the controller 2 comprises in addition a cross-reference table 2c, which is formed by a common memory that is associated to the detection means 2b.

When the Channel ID of a packet is recognized, the table 2c correlates the identity of the Channel ID to a context that is to be used for further processing.

To signal the context change to the successive processing means following the device, a context change signal is addressed in direction of the blocs 3,4 and 5 as shown in FIG. 1.

First the filtering processor bloc 3 receives the context change signal, which indicates the new context to be used.

The processor 3 contains in its associated memory the filtering parameters included in each processing context.

At the reception of signal S the processor can get back from its memory the filtering parameters corresponding to the context to be used.

The memory dedicated to the processor (which will be usually a random access memory RAM) serves for the storage of the contexts as well as for the storage of the filtering programs.

In fact, the processor 3 executes the program corresponding to the context because of an adapted instruction set.

When context changes occur, the processor registers are saved in the memory dedicated to the processor.

The processor uses a payload start signal for reinitializing its program counter, if the packet that corresponds to the modification of the context contains the payload beginning.

It equally contains an internal counter that allows knowing the number of bytes remaining in the data to be filtered.

Following the filtering processor, the device according to the invention comprises a FIFO register 4 (first in first out), which itself is indexed to the context because of the context change signal S received from the controller 2.

The FIFO register 4 comprises a fast memory RAM allowing storage of data organized in FIFO.

When a context change occurs pointers of the FIFO register 4 are associated to the data contained in the memory.

The FIFO register 4 will store the data during the period of correlation (period of match) of the filter before sending them to the next bloc or eliminating them.

The next bloc in FIG. 1 is the marker 5.

It has got the function to identify precisely each data coming out of the filtering process.

There again, the sort of marking depends on the associated context according to the information delivered by the controller 2 with the signal S.

More precisely, marker 5 adds to the filtered data marking data, that correspond to the packet identifier (Channel ID) to which they belong as well as a mark of the filter used for their filtering.

At the output of marker 5 the filtered data may be used by means of application of current type, especially a direct access memory.

Next will be described a possible application of the invention by way of the example of the processing of one packet.

When a packet in the entering flow 1 is received, it may perhaps pass a FIFO stack 2a that allows regulating the data rate.

When entering, the packet is recognized by the detection means 2b, which extract information concerning the Channel ID of the packet.

Dependent on the Channel ID, the controller 2 associates to the packet a context conform to a cross-reference table 2c.

The controller 2 outputs the data flow with a regulated rate as well as information about the context, given by a context change signal S.

As soon as the memory associated to a filtering processor 3 receives this context change signal S, it actualizes the filtering program according to the instructions relative to the context to apply.

Thus the processor uses new filtering parameters.

The program that uses the filtering processor 3 for each context could be as follows.

A limited set of instructions may be used allowing all the same the realization of all necessary filtering.

The instructions could be the following:

| | |
|---|---|
| STORE #Flt | Store a section on the filter Fit |
| DNE #Data, #Mask | Drop if Not Equal: Drop a section if the |
| | comparison is wrong |
| SEQ #Data, #Mask | Skip if Equal: Skip the next instruction if |
| | the comparison is right and store the data |
| SNE #Data, #Mask | Skip if Not Equal: Skip the next instruction |
| | if the comparison is wrong |
| GOTO | Go to an address |

A register contains the actual byte coming from the flow, which will serve for the comparison carried out by the filtering.

For the instructions DNE, SEQ and SNE mentioned above, it is possible to specify, if the instruction must use the data already present in the register or wait for the arrival of the next data.

In the case of an immediate processing (divergence of the filtering tree) the extension .imm will further on distinguish the instructions to be executed immediately DNE.imm, SEQ.imm and SNE.imm.

After a storage instruction (STORE), the program stops and the section is send to the output.

Once the section is filtered, execution restarts at the beginning of the program.

If the comparison of an instruction DNE is wrong, the program stops and restarts at the beginning, at the end of the actual section.

Advantageously, the filters that are to be created for each Channel ID are organized in a particular manner.

In fact, these filters organized by Channel ID can present themselves in an arborescent manner according to their common data concerning their length, the data and the mask of correlation (of match) that they contain.

It follows an example for five filters available for the processing of a packet with a determined CHANNEL ID:

| | | | | | | | |
|---|---|---|---|---|---|---|---|
| filter 1 | data | 0x81 | | | | | |
| | mask | 0xFF | | | | | |
| filter 2 | data | 0x84 | 0x33 | 0x54 | 0x63 | | |
| | mask | 0xFF | 0xFF | 0xFF | 0xFF | | |
| filter 3 | data | 0x88 | 0x12 | 0xA8 | 0xB3 | 0x00 | 0x98 |
| | mask | 0xFF | 0xFF | 0xFF | 0xFF | 0x00 | 0xFF |
| filter 4 | data | 0x88 | 0x22 | 0x65 | 0x30 | | |
| | mask | OxFF | OxFF | OxFF | OxFO | | |
| filter 5 | data | 0x88 | 0x12 | OxFF | OxFF | 0x02 | |
| | mask | 0xFF | 0xFF | 0xFF | 0xFF | 0x03 | |

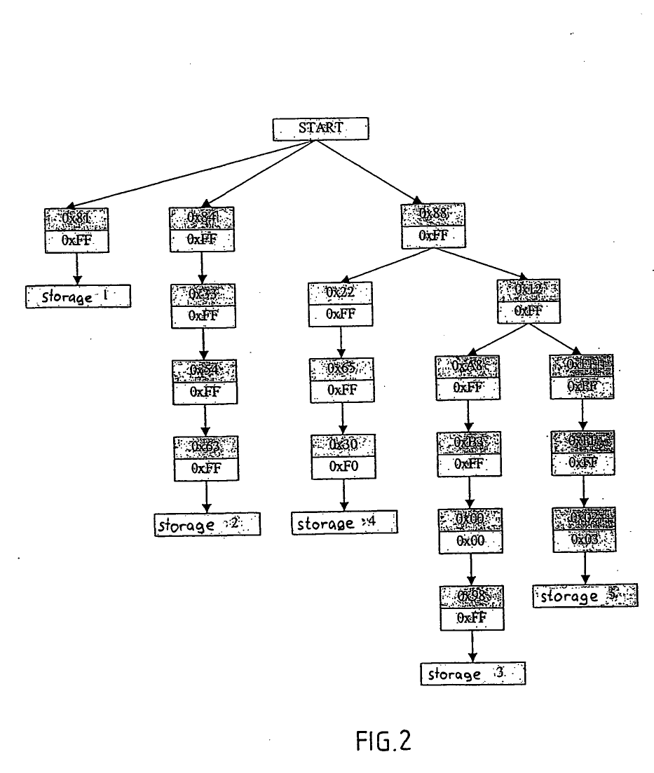

When the program is executed, the arborescent structure as shown in FIG. 2 is obtained.

It is to be noticed, that steps common to different filters are executed before a divergence of the tree when elements that are not common are to be used for the instructions.

By way of example, the program code may be as follows:

Start:

SNE #81, #FF

STORE #1

SNE.imm #84, #FF

GOTO Filter2_{—}1

DNE.imm #88, #FF

SNE #22, #FF

GOTO Filter4_{—}1

DNE.imm #12, #FF

SNE #A8, #FF

GOTO Filter3_{—}1

DNE.imm #FF, #FF

DNE #FF, #FF

DNE #02, #03

STORE #5

Filter2_{—}1:

DNE#33,#FF

DNE #54, #FF

DNE #63, #FF

STORE #2

Filter4_{—}1:

DNE #65, #FF

DNE #30, #F0

STORE #4

Filter3_{—}1:

DNE#B3,#FF

DNE #00, #00

DNE #98, #FF

STORE #3

Thus, an optimized filtering step is obtained, which uses regarding hardware only one filtering processor but which can work with several filtering parameters according to the Channel ID associated to the packets.

Additionally, the necessary succession of filtering instructions for each packet itself is optimized by the thus described arborescent structure.

Follows next the marking step at marker 5 for identifying unambiguously the data source (the Channel ID associated to their packet) as well as the filter type used.

Thus is known exactly, which filter was released for the associated data.

### References

1. Entering flow

2. Controller

2a. FIFO stack

2b. Detection means

2c. Cross-reference table

3. Filtering processor

4. FIFO register

5. Marker

6. Application

7. Filtered data

S. Context change signal

1. A method for processing data of a multiplexed flow in which the data are organized in packets comprising an identifier that allows to describe to which source the data contained in the packet belong, the method comprising a data filtering step, characterized by the fact that
a) a cross-reference table is established in which each identifier is associated with a processing context,
b) for each entering packet:
its identifier is recognized
its data are filtered using the filtering parameters of its processing context
the filtered data are stored and marking data are added to the data filtered with a particular context for marking with the identifier of the packet to which they belong and marking with the filter that was used for their filtering.

2. The method of claim 1, characterized by the fact that at each change of the processing context to be used the filtered data are stored with the foregoing context in a FIFO register (4) of the first-in first-out type and a FIFO register pointer is associated to them.

3. The method according to any of the claims 1 to 2, characterized by the fact that the filtering parameters of each processing context comprise one or a plurality of filters each being provided with characteristics of data filtering, of mask and of length.

4. The method of claim 3, characterized by the fact that the filtering is executed by organizing the filters arborescently, where the common elements are grouped together on a same branch.

5. A device for processing data of a multiplexed flow in which the data are organized in packets comprising an identifier allowing to describe to which source belong the data that they contain, the device comprising means for data filtering, which can be used by the method according to any of the claims 1 to 4, characterized by the fact that it comprises:
means for storing a cross-reference table (2c) that associates each identifier with a processing context,
means for detecting (2b) the identifier of a packet entering the device
a filtering processor (3) that is associated with a memory which contains the filtering parameters included in each processing context
means for storing the filtered data
it contains a marker (5) to add marking data to the filtered data for marking with the identifier of the packet to which they belong and with the filter that was used for their filtering
for filtering the data of a packet according to filtering parameters which are applied to the filtering processor (3) after recognition of the packet identifier and association of the processing context which contains these filtering parameters with this identifier.

6. The device of claim 5, characterized by the fact that
the means for storing the filtered data consist of a FIFO register (4) of the first-in first-out type, whose pointers are associated with the filtered data according to their context.

7. The device according to any of the claims 5 to 6, characterized by the fact that the multiplexed flow is a flow of digital broadcasting.

8. The device of claim 7, characterized by the fact that the multiplexed flow is a digital television flow.
